(19) United States
(12) Patent Application Publication
(10) Pub. No.: US 2007/0094664 A1
(43) Pub. Date: Apr. 26, 2007

(54) Programmable priority for concurrent multi-threaded processors

(76) Inventors: Kimming So, Palo Alto, CA (US); Baobinh Truong, San Jose, CA (US); Yang Lu, Palo Alto, CA (US); Hon-Chong Ho, Fremont, CA (US); Li-Hung Chang, Santa Clara, CA (US); Chia-Cheng Choung, Fremont, CA (US); Jason Leonard, San Jose, CA (US)

Correspondence Address: BRAKE HUGHES BELLERMANN LLP, C/O INTELLEVATE, P.O. BOX 52050, MINNEAPOLIS, MN, 55402, US

(21) Appl. No.: 11/256,631

(22) Filed: Oct. 21, 2005

(51) Int. Cl. G06F 9/46

(52) U.S. Cl. 718/103

(57) ABSTRACT

A first thread processor of a multi-thread processor system is operable to execute a first process, and a second thread processor of the multi-thread processor system is operable to execute a second process. A control register is operable to store priority information that is individually associated with at least one of the first thread processor and the second thread processor. The priority information identifies a prioritization of the first thread processor and/or a restriction on the second thread processor in a use of a shared hardware resource during execution of at least one of the first process and the second process.

### TECHNICAL FIELD

This description relates to multi-threaded processors.

### BACKGROUND

Techniques exist that are designed to increase an efficiency of one or more processors in the performance of one or more processes. For example, some such techniques are used when it is anticipated that a first processor may experience a period of latency during a first process, such as when the first processor is required to wait for retrieval of required data from a memory location. During such periods of latency, a second processor may be used to perform a second process, e.g., the second processor may be given access to a resource being used by the first processor during the first process. Additionally, or alternatively, the first processor and the second processor may implement the first and second processes substantially in parallel, without either processor necessarily waiting for a period of latency in the other processor. In the latter examples, then, it may occur that the first processor and the second processor both require use of, or access to, a shared resource (e.g., a memory), at substantially a same time. By interleaving operations of the first processor and second processor, and by providing fair access to the shared resource(s), both the first and second processes may be completed sooner, and more efficiently, than if the first and second processes were performed separately, e.g., in series.

In these and other examples, the processor(s) need not represent entirely separate physical processors that are accessing shared resources. For example, a single processor may switch between processes to achieve similar results. In a related example, a processor system implemented on a semiconductor chip may emulate a plurality of processors and/or perform a plurality of processes, by, e.g., duplicating certain execution elements for the processing. These execution elements may then be used to share various resources (e.g., memories, buffers, or interconnects), which themselves may be formed on or off the chip, in order to implement the first process and the second process.

### SUMMARY

According to one general aspect, priority information is set in a control register, the priority information being related to a first thread processor and a second thread processor. A first process is executed with the first thread processor and a second process is executed with the second thread processor. The first thread processor is prioritized in performing the first process relative to the second thread processor in performing the second process, based on the priority information as determined from the control register.

According to another general aspect, an apparatus includes a first thread processor that is operable to execute a first process, and a second thread processor that is operable to execute a second process. A control register is included that is operable to store priority information that is individually associated with at least one of the first thread processor and the second thread processor, the priority information identifying a restriction on a use of a shared hardware resource by the second thread processor during execution of at least one of the first process and the second process.

According to another general aspect, an apparatus includes a plurality of thread processors that are operable to perform a plurality of processes, a shared hardware resource used by the thread processors in performing the processes, a controller associated with the shared hardware resource and operable to receive contending requests for the shared hardware resource from the plurality of thread processors, and a control register associated with the shared hardware resource and operable to store priority information regarding use of the shared hardware resource by the plurality of thread processors. The controller is operable to receive the contending requests and access the control register to provide use of the shared hardware resource to a prioritized thread processor of the plurality of thread processors, based on the priority information.

The details of one or more implementations are set forth in the accompanying drawings and the description below. Other features will be apparent from the description and drawings, and from the claims.

### BRIEF DESCRIPTION OF THE DRAWINGS

FIG. 1 is a block diagram of a programmable multi-thread processor system.

FIG. 2 is a flowchart illustrating an operation of the system of FIG. 1.

FIG. 3 is an example processor system of the system of FIG. 1.

FIG. 4 is a block diagram of a cache memory of the processor system of FIG. 3.

FIG. 5 is a flowchart illustrating a first operation of the processor system of FIG. 3.

FIG. 6 is a flowchart illustrating a second operation of the processor system of FIG. 3.

### DETAILED DESCRIPTION

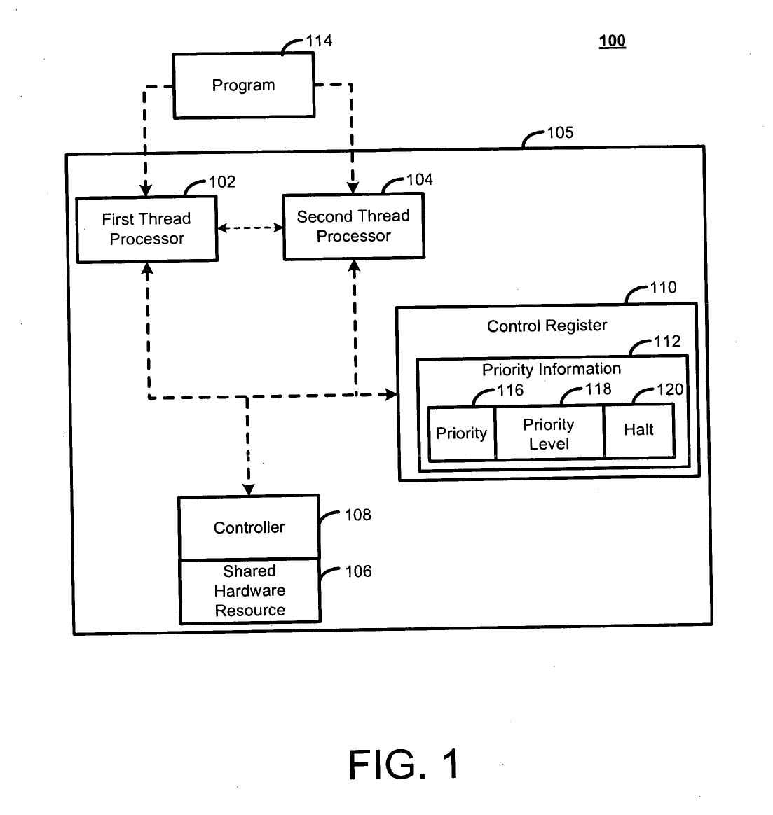

FIG. 1 is a block diagram of a programmable multi-thread processor system 100. In the system 100, at least one thread processor of multiple thread processors may be prioritized during implementation of its associated process(es), relative to other ones of the multiple thread processors. In this way, for example, the associated process may be performed more quickly than would be the case without the prioritization.

Thus, in the example of FIG. 1, a first thread processor 102 and a second thread processor 104 may be used to implement first and second processes, respectively. For example, the first thread processor 102 and/or the second thread processor 104 may include and/or be associated with a number of elements and/or resources that are formed on a substrate for inclusion on a semiconductor chip 105, and that may be used in the performance of various types of computing processes.

Such elements or resources may include, for example, functional units that perform various activities associated with the processes. Although not specifically illustrated in FIG. 1, such functional units are generally known, for example, to obtain instructions from memory, decode the instructions, perform calculations or operations, implement software instructions, compare results, make logical decisions, maintain a current state of a process/processor, and/or communicate with external elements/units.

For example, an arithmetic-logic unit (ALU) may perform, or may enable the performance of, logic and arithmetic operations (e.g., to add, subtract, multiply, or divide). For example, an ALU may add the contents of a register, for storage of the results in another register. A floating-point unit and/or fixed-point unit also may be used for corresponding types of mathematical operations.

In implementing the first process and the second process, some of the elements or resources of the first thread processor 102 and the second thread processor 104 may be shared between the two, while others may be duplicated for partial or exclusive access thereof by the first thread processor 102 and the second thread processor 104. For example, shared resources (e.g., a shared memory) may be used by both of the first thread processor 102 and the second thread processor 104, while duplicated elements (e.g., instruction pointers for pointing to the next instruction(s) to be fetched) may be devoted entirely to their respective thread processor(s).

For example, in concurrent multi-threaded processors, a thread processor may have its own program counter, general register file, and general execution unit (e.g., ALU). Meanwhile, other execution units, such as, for example, floating point or application specific execution units (e.g., digital signal processing (DSP) units) may either be shared or may not be shared between the thread processors.

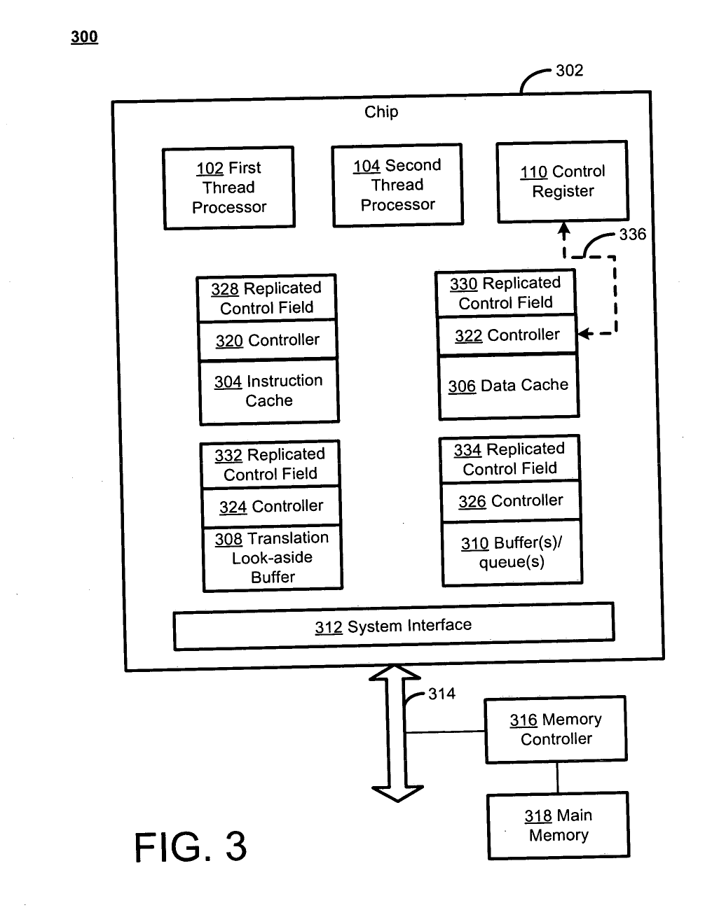

In the example of FIG. 1, the first thread processor 102 and the second thread processor 104 both make use of a shared hardware resource 106. For example, the shared hardware resource 106 may represent any hardware resource that is accessed or otherwise used by both the first thread processor 102 and the second thread processor 104 in performing the first and second process, respectively. Some examples of the shared hardware resource 106 include cache(s) or other memory, memory controllers, buffers, queues, interconnects, or any other hardware resource that may be used by the first thread processor 102 and/or the second thread processor 104. Other examples of the shared hardware resource 106 are provided in more detail, below, with respect to FIG. 3.

In implementing the first and second processes, the first thread processor 102 and the second thread processor 104 may be required to contend for use of the shared hardware resource 106. For example, the first thread processor 102 and the second thread processor 104 may both attempt to access the shared hardware resource 106 at substantially a same time (e.g., within a certain number of processor cycles of one another). In such cases, requests for the shared hardware resource 106 from the first thread processor 102 and the second thread processor 104 may be received at a controller 108 for the shared hardware resource 106. For example, where the shared hardware resource 106 includes a cache, the controller 108 may include a cache controller that is typically used to provide cache access to one or more processors, and that is implemented to communicate with a control register 110.

As described in more detail below, e.g., with respect to FIG. 3, the control register 110 refers generally to a register or other memory that is accessible by the first thread processor 102, the second thread processor 104, or the shared hardware resource 106, and that stores priority information 112 for designating a priority of the first thread processor 102 or the second thread processor 104 in implementing the first process or the second process, respectively. For example, contents of the priority information 112 within the control register 110 may be programmed or otherwise caused to be set, re-set, or changed in various ways during the first process and the second process. For example, one or more programs (represented in FIG. 1 by a program 114) with instructions for implementing the first process and the second process may be loaded to the first thread processor 102 and/or the second thread processor 104 on the chip 105. The program 114 may include instructions for dynamically programming the control register 110 during the execution of the first process and the second process.

For example, based on instructions of the program 114, the priority information 112 may be programmed at a particular time to provide the first thread processor 102 with priority access to the shared hardware resource 106, during a designated job of the first process. Later, the priority information 112 may be re-set, such that the second thread processor 104 is provided with priority access to the shared hardware resource 106, during a later-designated job of the second process. In other words, the priority information 112 may be determined and/or altered dynamically, including during a run time of the first process and/or the second process of the program 114. In this way, for example, a desired one of the first thread processor 102 and the second thread processor 104 may be provided with a desired type and/or extent of prioritization, during particular times and/or situations that may be desired by a programmer of the program 114.

The priority information 112 may be set within the control register 110 by setting pre-designated bit patterns (also referred to as “priority bits”) within designated fields of the control register 110. In the example of FIG. 1, the priority information 112 includes a designation of which of the first thread processor 102 and the second thread processor 104 is currently provided with priority with respect to accessing the shared hardware resource 106, using a priority identifier field 116. The priority information 112 also includes a priority level field 118 that designates a type or extent of priority that is to be provided to the thread process designated within the priority identifier field 116. The priority information 112 also includes a halt field 120 that, when activated, indicates that one of the first thread processor 102 and the second thread processor 104 should be temporarily but completely halted in performing its associated job and/or process.

For example, the priority identifier field 116 may include one or more bits, where a value of the bit(s) as either a “1” or a “0” may indicate that either the first thread processor 102 or the second thread processor 104 currently has priority with respect to the shared hardware resource 106. Where more than two thread processors are used, an appropriate number of bits may be selected to indicate a thread processor that currently has priority with respect to access of the shared hardware resource 106.

The priority level field 118 also may include one or more bits, where the bits indicate a type or extent of priority, as just mentioned. For example, a bit pattern corresponding to a “fair” priority level may indicate that, notwithstanding the designation in the priority identifier field 116, no priority should be granted to either the first thread processor 102 or the second thread processor 104. That is, the priority level field 118 may indicate, for example, that access to the shared hardware resource 106 should be provided fairly to the first thread processor 102 and the 104, e.g., on a first-come, first-serve basis. In this case, if access requests from the first thread processor 102 and the second thread processor 104 for access to the shared hardware resource 106 are placed into buffers or queues (not shown in FIG. 1), then the access requests may be chosen randomly in order to provide fair access to the shared hardware resource 106. In such cases, in some implementations, the thread processor associated with the chosen access request may be assigned a relatively lower priority with respect to future access requests (e.g., the first thread processor 102 may not be allowed consecutive accesses to the shared hardware resource 106).

Another priority level that may be indicated by a bit pattern within the priority level field 118 may be used to designate that when both of the first thread processor 102 and the second thread processor 104 attempt to access the shared hardware resource 106 at substantially a same time, the higher-priority thread processor (as designated in the priority identifier field 116) will be allowed the access, while the other thread processor waits for access. For example, access requests from the first thread processor 102 and the second thread processor 104 for access to the shared hardware resource 106 that are placed into a buffer or queue (not specifically shown in FIG. 1) may be selected from the buffer/queue according to the priority level indicated in the priority identifier field 116. For example, if the first thread processor 102 is designated in the priority identifier field 116 as the higher-priority thread processor, then access requests of the first thread processor 102 within the buffer/queue may be selected ahead of access requests from the second thread processor 104.

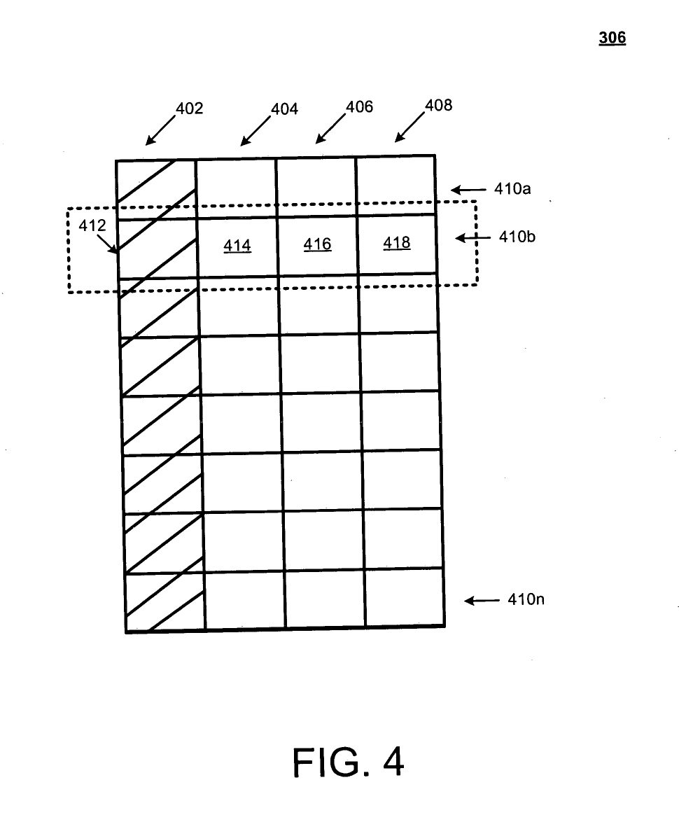

Another level of priority that may be designated in the priority level field 118 refers to a restriction or limit placed on the access of the shared hardware resource 106 by the first thread processor 102 and/or the second thread processor 104. For example, where the shared hardware resource 106 includes a set-associative cache, the lower-priority of the first thread processor 102 and the second thread processor 104 ( as designated in the priority identifier field 116) may be restricted from re-filling a designated portion of the cache, after a cache miss by that lower priority thread processor. In another example, a cache may simply be partitioned so as to provide the higher-priority thread processor with a greater level of access. Further examples of how priority may be assigned with respect to a cache memory are provided below, e.g., with respect to FIG. 4.

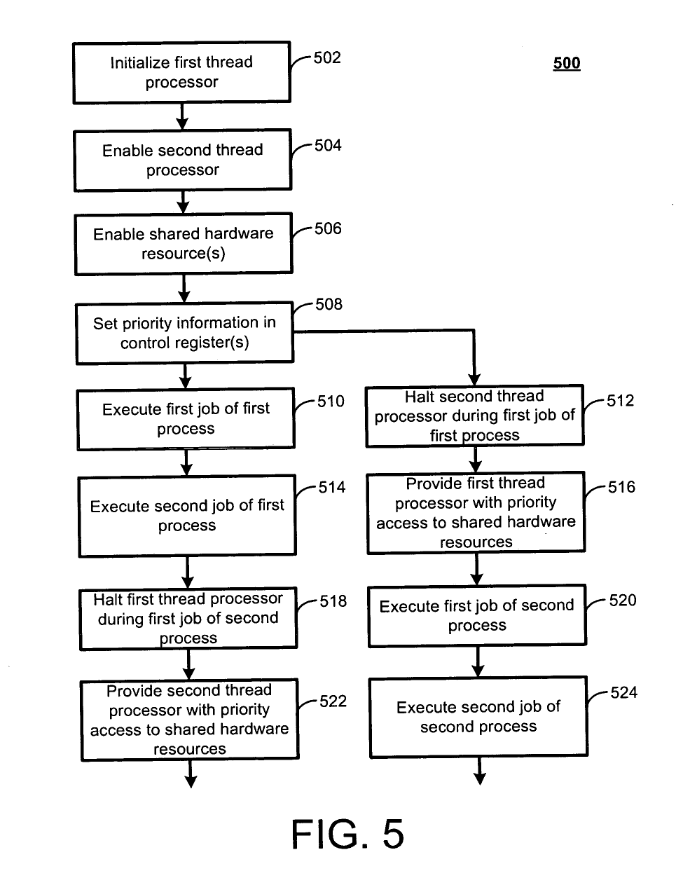

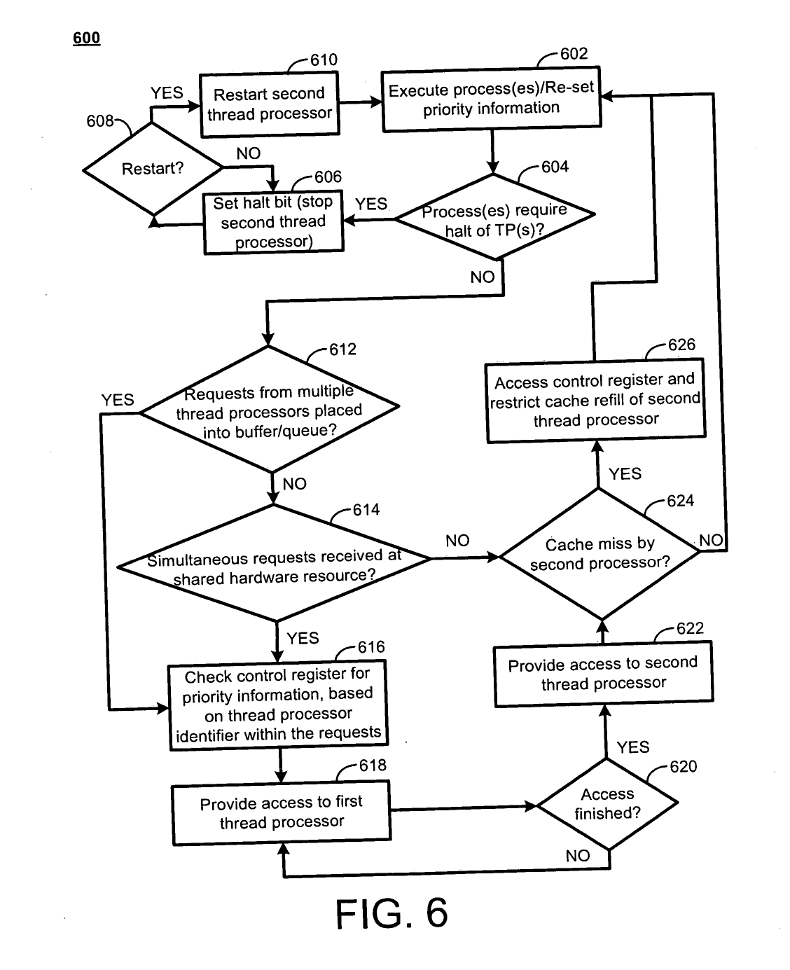

Finally in FIG. 1, the halt field 120 may include a designated bit for each of the first thread processor 102 and the second thread processor 104 (or for however many thread processors are included in the system 100). When a halt bit associated with a particular thread processor is set, e.g., from “0” to “1”, then that thread processor is halted until the associated halt bit is re-set, e.g., from “1” back to “0.” Additional examples of the halt field 120 are provided in more detail below, e.g., with respect to FIGS. 5 and 6.

When a plurality of shared hardware resources are used within a multi-thread processing system, the priority information 112 within the control register 110 may indicate whether, when, and to what extent each of the shared hardware resources should provide priority access to one of a plurality of thread processors attempting to access the shared hardware resource at a given time. According to the program 114, such priority indications may change over time as individual jobs of the processes of the program 114 are executed by the plurality of thread processors. Accordingly, high-priority jobs may be designated dynamically, and may be performed as quickly as if only a single thread processor were being used.

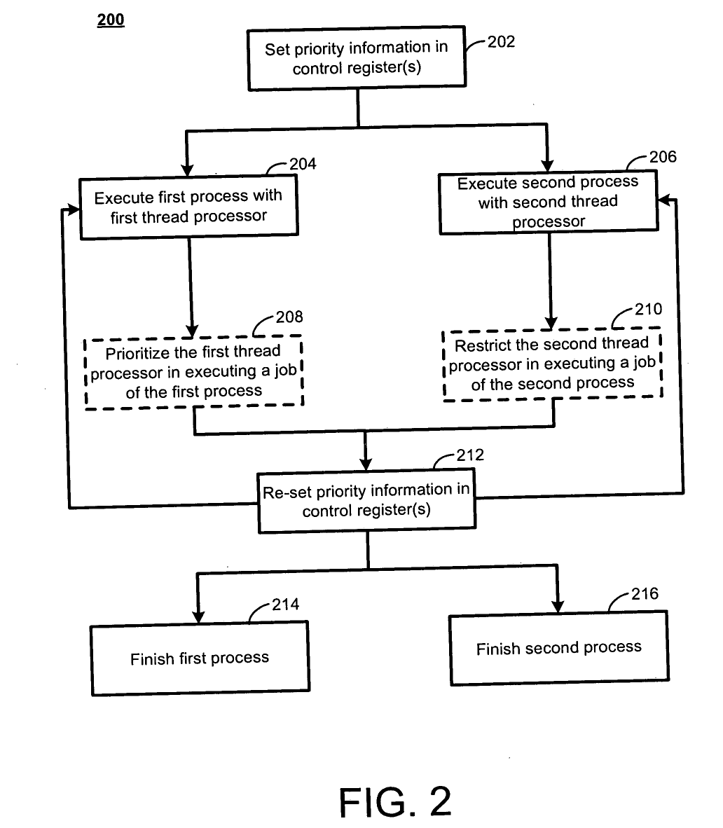

FIG. 2 is a flowchart 200 illustrating an operation of the system 100 of FIG. 1. In the example of FIG. 2, priority information is set in one or more control registers (202). For example, the priority information 112 may initially be set in the control register 110 in response to a loading of the program 114 to the first thread processor 102. In some implementations, at least some of the priority information 112 may be static, and will be stored and maintained throughout an execution of the program 114. Additionally, or alternatively, some or all of the priority information 112 may be dynamic, and may change during an execution of the program 114. For example, a partitioning of a cache that is set in the priority information 112 may be performed once during a loading of the program 114 and/or during an initialization of the first thread processor 102, while, as discussed in more detail below, a priority designation and/or a priority level of the first thread processor 102 and/or the second thread processor 104 may be changed one or more times during execution of the program 114.

Once the priority information 112 is initially set and the first thread processor 102 and the second thread processor 104 are otherwise initialized/enabled (along with the shared hardware resource 106), then a first process may be executed with the first thread processor 102 (204), while a second process may be executed with the second thread processor 104 (206). In this regard, and consistent with the terminology used above with respect to FIG. 1, it should be understood that the term “process” is used to refer to a portion of execution of the program 114 at a given one of the first thread processor 102 and the second thread processor 104, while the term “job” is used to refer to a sub-unit of a process. That is, the program 114 may include one or more processes, each performed on one or both of the first thread processor 102 and/or second thread processor 104, and each process may include one or more jobs. Of course, other terminology may be used (e.g., “task” instead of “job”), and some implementations may include a process that is not divisible into jobs or tasks. Also, one or more threads may be included in a process, where each of the first thread processor 102 and the second thread processor 104 are operable to implement separate threads, as should be apparent. Other variations in terminology and execution would be apparent, as well. However, the use of the just-described terminology allows for illustration of the point that the priority information 112 may vary on one or more of a program, process, thread, or job-specific basis, as described in more detail below.

For example, once the priority information 112 is set and the processes are executed, the first thread processor 102 may be prioritized in executing a job of the first process (208). For example, as discussed above, the first thread processor 102 may gain priority access to the shared hardware resource 106 when contending with the second thread processor 104, as determined by the controller 108 from the priority information 112 in the control register 110. For example, where the shared hardware resource 106 includes a cache, and the first thread processor 102 and the second thread processor 104 execute overlapping requests for access thereto, then the controller 108 may check the priority information 112 to determine that the first thread processor 102 should be provided access to the cache. Similarly, where the shared hardware resource 106 includes a buffer or queue, and the first thread processor 102 and the second thread processor 104 both have access requests in the buffer/queue, then the controller 108 of the buffer/queue may check the priority information 112 to move the access request(s) of the first thread processor 102 ahead of the access request(s) of the second thread processor 104.

Put another way, the second thread processor 104 may be seen as being restricted in executing a job of the second process (210). For example, the second thread processor 104 may be seen as being partially restricted, in time and/or extent, from accessing the shared hardware resource 106 in any of the cache/buffer/queue examples just given. Further, a full restriction of the second thread processor 104 may be seen to occur when the halt field 120 is set to a halt position, in which case the second thread processor 104 will stop the execution of the second process until the halt field 120 is re-set from the halt position.

Once the job(s) of the first process and/or the second process are finished, then the priority information in the control register(s) may be re-set (212). For example, the program 114 may program the control register 110 to give a certain type or extent of priority to the first thread processor 102 during a first job of the first process, and, after the first job is completely, may dynamically re-program the control register 110 to give a different type or extent of priority to the first thread processor 102. Further, although not explicitly illustrated in FIG. 2, it should be understood that the program 114 may program the priority information 112 in the control register 110 such that the second thread processor 104 is provided with priority access to the shared hardware resource 106 during a job(s) of the second process, and/or may restrict the first thread processor 102 in performing a job(s) of the first process (including halting the first thread processor 102). In other words, and as described in more detail below with respect to FIG. 5, the priority information 112 may be dynamically set and re-set not only on a job-by-job basis for a given thread processor, but also may be set or re-set between the first thread processor 102 and the second thread processor 104 (or other thread processors that may be present), as well.

Thus, the execution of the first and second processes may continue (204, 206) with the new prioritization/restriction settings in place (208, 210), and with the priority information 112 being re-set (212), as appropriate (e.g., as mandated by the program 114). This cycle(s) may continue until the first process is finished (214) and the second process is finished (216).

FIG. 3 is an example processor system 300 of the system 100 of FIG. 1. The example of FIG. 3 illustrates a chip 302 that is analogous to the chip 105 of FIG. 1. In FIG. 3, the first thread processor 102, the second thread processor 104, and the control register 110 are illustrated, along with several examples of the shared hardware resource 106 and the controller 108, as described in more detail, below.

For example, the chip 302 includes an instruction cache 304, a data cache 306, a translation look-aside buffer (TLB) 308, and one or more buffers and/or queues (310). These examples of the shared hardware resource 106, by themselves, are generally known to include certain functions and purposes. For example, the instruction cache 304 and the data cache 306 are generally used to provide program instructions and program data, respectively, to one or both of the first thread processor 102 and the second thread processor 104. Such separation of instructions and data is generally implemented to account for differences in how and/or when these two types of information are accessed. Meanwhile, the translation look-aside buffer 308 is used as part of a virtual memory system, in which a virtual memory address is presented to the translation look-aside buffer 308 and a corresponding cache (e.g., the instruction cache 304 or the data cache 306), so that cache access and virtual-to-physical address translation may proceed in parallel. Also, the buffer/queue 310 refers generally to one or more buffers and/or queues that may be used to store commands or requests, either to the instruction cache 304, the data cache 306, the translation look-aside buffer 308, or to any number of other elements that may be included on (or in association with) the chip 302.

Additionally, a system interface 312 allows the various on-chip components to communicate with various off-chip components, usually over one or more busses represented by a bus 314. For example, a memory controller 316 may be in communication with the bus 314, so as to provide access to a main memory 318. Thus, as is known, the instruction cache 304 and/or the data cache 306 may be used as temporary storage for portions of information stored in the main memory 318, so that an access time of the first thread processor 102 and the second thread processor 104 in obtaining such information may be improved. In this regard, it should be understood that a plurality of levels of caches may be provided, so that most-frequently accessed information may be accessed most quickly from a first level of access, while less-frequently accessed information may be stored at a second cache level (which may be located off of the chip 302). In this way, access to stored information may be optimized, and a need to access the main memory 318 is minimized. However, such multi-level caches, among various other elements, are not illustrated in the example of FIG. 3, for the sake of brevity and clarity.

The instruction cache 304, the data cache 306, the translation look-aside buffer 308, and the buffer/queue 310 include, respectively, controllers 320, 322, 324, and 326. As described above, such controllers may be used, for example, when one of the instruction cache 304, the data cache 306, the translation look-aside buffer 308, or the buffer/queue 310 receives substantially simultaneous or overlapping access or use requests from both the first thread processor 102 and the second thread processor 104. For example, if the instruction cache 304 receives such competing requests from the first thread processor 102 and the second thread processor 104, then the controller 320 may access appropriate fields of the control register 110 to determine a current state of the priority information 112 contained therein (as seen in FIG. 1). If the first thread processor 102 is indicated as having higher priority for accessing the instruction cache 304 than the second thread processor 104, then the controller 320 may allow access of the first thread processor 102 to the instruction cache 304 for obtaining instruction information therefrom.

It should be understood that similar comments may apply to the system interface 312, the main memory 318, and other elements associated with the chip 302 that may or may not be illustrated in FIG. 3. That is, any such shared hardware resource may determine, from the priority information 112, whether and how to provide priority access to the first thread processor 102 or the second thread processor 104. Accordingly, any such shared hardware resource may be associated with a controller for making such determinations, although such controller(s) may take various forms/structures, and, for example, need not be physically separate from the associated shared hardware resources, or may be shared between multiple shared hardware resources.

Multiple techniques may be used to allow the elements associated with the chip 302 to determine the priority information 112 from the control register 110. For example, the controller 320 may receive a first request for access to the instruction cache 304 from the first thread processor 102, and a second request for access from the second thread processor 104, and may thus need to access the priority information 112 within the control register 110 to determine relevant priority information. In this case, the controller 320 may analyze the first request and the second request to determine a thread processor identifier associated with each request (so as to be able to correspond the requests with the appropriate thread processors), access corresponding priority fields within the control register 110, and then allow access to the access request associated with the higher-priority thread processor.

In the example of FIG. 3, a replicated control field 328 represents a duplication of the priority information 112 within the control register 110 that is associated with the instruction cache 304. That is, when the priority information 112 within the control register 110 is set (or re-set) according to the program 114 or other criteria, then each field(s) within the priority information 112 that corresponds to the instruction cache 304 may be propagated and copied to the replicated control field 328. In this way, the controller 320 may make priority decisions for access to the instruction cache 304 quickly and reliably.

Similarly, a the controller 322 is associated with a replicated control field 330, while the controller 324 is associated with a replicated control field 332, and the controller 326 is associated with a replicated control field 334. In this way, portions of the control register 110 that are relevant to the various shared hardware resources of the chip 302 are replicated in association with the corresponding ones of the shared hardware resources, so that priority decisions may be made quickly and reliably throughout the chip 302.

In other implementations, specific fields within the control register 110 may be wired directly to corresponding ones of the controller 320, the controller 322, the controller 324, and the controller 326, in which case no replication of control fields may be required. Such a direct wiring is illustrated in FIG. 3 as a single connection 336, although it should be understood that the connection 336 may typically, but not necessarily, be redundant to the replicated control field 330. Generally speaking, the replicated control field(s) may be used for circuits in which the priority information 112 is not updated very frequently, and/or where repeated priority determinations need to be made at a particular shared hardware resource. Conversely, the use of direct wiring (as represented by the connection 336) may be advantageous in situations where the priority information 112 is updated very frequently, so that (frequent) replications of the priority information 112 to the replicated control field(s) may not be possible or practical.

Regarding the halt field 120, it should be understood that whichever of the first thread processor 102 or the second thread processor 104 currently is assigned a higher priority may be enabled to set the halt field 120 for the other thread processor to a halt setting, so that the other thread processor may be halted. As such, both of the first thread processor 102 and the second thread processor 104 should be understood to be wired to, or otherwise in communication with, the control register 110. In this way, for example, an action of the first thread processor 102 in setting the halt field 120 for the second thread processor 104 to a halt setting (again, assuming for the example that the first thread processor 102 has the priority/authorization to do so) is automatically and quickly propagated to the second thread processor 104, and the second thread processor 104 will be halted until the first thread processor 102 re-sets the halt field 120 for the second thread processor 104 to remove the halt setting (e.g., by switching a halt bit from “1” back to “0,” or vice-versa).

FIG. 4 is a block diagram of a cache memory (i.e., the data cache 306) of the processor system of FIG. 3. Generally speaking, as referenced above, a cache allows data from the main memory 318 (e.g., data that has most recently been requested by one of the first thread processor 102 or the second thread processor 104) to be temporarily stored, in order to allow faster access to that same data at a later point in time. More specifically, data stored in such a cache typically may include not just the data that was requested from the main memory 318, but also may include data that is related to the requested data, such as data that is stored close to the requested data within the main memory 318 (e.g., data that is stored at nearby physical memory addresses within the main memory 318). The retrieval of the related data from the main memory 318 is performed on the supposition that the related data will be likely to be related to the requested data not just in location, but in content, and, therefore, will be likely to be requested itself in the near future.

In general terms, then, for example, the first thread processor 102 may issue a request for data from the data cache 306, by sending a memory address to the data cache 306. The data cache 306 may then attempt to match the memory address within an address of the data cache 306, and, if there is a match (also referred to as a “hit”), then data within the data cache 306 associated with the memory address is read from the data cache 306. On the other hand, if there is not a match (also referred to as a “miss”), then the first thread processor 102 and/or the data cache 306 must request data from the memory address from the main memory 318. However, as already mentioned, it may be inefficient to obtain only the requested data from the main memory 318, and, instead, the requested data is retrieved from the main memory 318 together with a block of related data, all of which may then be stored in the data cache 306.

In attempting to match the requested memory address within the data cache 306, it should be understood that trying to match the requested memory address to any possible address within the data cache 306 may be relatively time-consuming, and may at least partially offset the advantage of using the data cache 306 in the first place. Therefore, in FIG. 4, a four-way set-associative cache is used, in which four “ways” are designated as way-1 402, way-2 404, way-3 406, and way-4 408. Further, indices of each way are designated as 410a, 410b, . . . , 410n. In this way, only a portion of the requested memory address may be used to limit an attempted match of the requested memory address to one of the indices 410a, 410b, . . . , 410n. More specifically, each index includes four “lines” that correspond to one of the four “ways” of the set-associative cache. For example, the index 410b includes a first line 412, a second line 414, a third line 416, and a forth line 418.

In this way, a requested memory address is first limited to the index 410b, and only the four lines 412, 414, 416, and 418 then need to be checked for a match with the memory address (using the entirety of the memory address). If a match is found, then the corresponding data is read from the corresponding line (where the data may occupy a relatively small area of the line). If, however, a match is not found (i.e., a “miss” occurs), then an entire line (e.g., the line 414) may typically be replaced by obtaining from the main memory 318 both the requested data (i.e., data from the main memory 318 at the provided memory address) and an associated quantity of data from the main memory 318 that is related to the requested data and sufficient to fill the line.

In FIG. 4, the way-1 402 is partitioned from the remainder of the data cache 306 and associated with the first thread processor 102, while the remainder of the data cache 306 is associated with the second thread processor 104. More specifically, for example, a priority level may be set in the priority level field 118 of the priority information 112 that designates such a partitioning/assignment of the data cache 306, so that either the first thread processor 102 or the second thread processor 104 may read data from any line or address of the data cache 306, but the first thread processor 102 may only cause a cache re-fill of the line 412 (or corresponding line within the way-1 402 that is shown with hash marks in FIG. 4). Conversely, the second thread processor 104 in this scenario may only cause a cache re-fill of the lines 414, 416, or 418. For example, a bit pattern may be set in the priority level field 118 in which a bit pattern “00” indicates that the first thread processor 102 is associated with the way-1 402, while a bit pattern “01” indicates that the first thread processor 102 is associated with the way-1 402 and the way-2 404. Similarly, a bit pattern “10” may indicate that the first thread processor 102 is associated with the way-1 402, the way-2 404, and the way-3 406, while a bit pattern “11” indicates that the first thread processor 102 is associated with the way-1 402, the way-2 404, the way-3 406, and the way-4 404.

Thus, if the first thread processor 102 requests data from the data cache 306, and it is determined from (designated bits of) the requested memory address that the requested data should be contained in the index 410b, then only the lines 412, 414, 416, and 418 need be checked for the full memory address/data. If the requested data is present (a “hit”), then the requested data is retrieved. If not (a “miss”), then the requested data is obtained together with additional, related data from the main memory 318, and is used to fill the line 412.

On the other hand, in a similar scenario with the second thread processor 104, the line 412 may not be re-filled after such a cache miss, since the line 412 is included in the way-1 402 that is reserved for re-fill by the first thread processor 102. Therefore, the second thread processor 104 would re-fill one of the remaining lines 414, 416, or 418 from the corresponding ways 404, 406, or 408.

By partitioning the data cache 306 in this manner, or a related manner, a higher-priority thread processor may be more likely to have required data within the data cache 306. For example, and by comparison, in a case where both the first thread processor 102 and the second thread processor 104 are sharing fair and equal access to the data cache 306, it may be the case that the first thread processor 102 has access to the data cache 306 for a period of time, during which various cache hits and misses may occur. For each miss, as described, corresponding data (generally related to the first process of the first thread processor 102) is read from the main memory 318 and used to re-fill one or more cache lines. Later, the second thread processor 104 may gain access to the data cache 306, and, may experience a number of cache misses (since the data cache 306 has just been filled with data pertinent to the first process of the first thread processor 102), thereby causing the data cache 306 to re-fill with data related to the second process of the second thread processor 104. As the first thread processor 102 and the second thread processor 104 alternate access, then, both the first thread processor 102 and the second thread processor 104 may experience inordinate delays as their respective data is retrieved from the main memory 318.

Using the partitioning scheme of FIG. 4, however, as described, data for each of the first thread processor 102 and the second thread processor 104 is not allowed to be re-filled into the partitioned/designated lines of the data cache 306. Thus, for example, even if the first thread processor 102 does not access the data cache 306 for some period of time, the first thread processor 102 will find that at least some of its most-recently used data is still available (e.g., within the way-1 402), and will therefore minimize or avoid additional retrievals from the main memory 318.

It should be understood that the example of FIG. 4 illustrates merely one implementation, and other examples also may be used. For example, a 2-way, 3-way, or n-way set-associative cache may be used. Also, partitioning may occur as would be apparent; e.g., instead of being partitioned in a 1:3 ratio, the 4-way set-associative cache of FIG. 4 may be partitioned in a 2:2 or 3:1 ratio.

FIG. 5 is a flowchart 500 illustrating a first operation of the processor system of FIG. 3. In the example of FIG. 5, the first thread processor 102 is initialized (502). For example, the first thread processor 102 may be initialized according to the program 114. Then, the second thread processor 104 may be enabled (504). For example, the first thread processor 102 may act to enable the second thread processor 104, based on the program 114. Similarly, any available or necessary shared hardware resources may then be enabled (506). For example, the shared hardware resource 106, which may include, by way of example, the instruction cache 304, the data cache 306, the translation look-aside buffer 308, or any of the other shared hardware resources mentioned herein, may be enabled by the first thread processor 102.

Priority information may then be set (508). For example, an initial programming of the priority information 112 within the control register 110 may occur, and may be propagated to the respective shared hardware resources using either a direct wiring and/or the replicated control fields of FIG. 3. It should be understood that some of the priority information 112 may be set in a static fashion, and may be maintained through most or all of the first process and the second process. For example, a partitioning of the data cache 306 may be initialized and set, and may be maintained thereafter. Other types of the priority information 112 may be re-set on a job-by-job basis, as described in more detail, below.

For example, in one implementation, a first job of the first process may occur (510), while priority bits may be set within the halt field 120 so as to indicate that the second thread processor 104 should be halted during this first job (512). In this way, the first thread processor 102 may complete the first job of the first process, very quickly, as if the first thread processor 102 were the only thread processor present in a processing system.

Then, a second job of the first process may be executed (514), while the first thread processor 102 is provided with priority access to any available shared hardware resources (516). In other words, the priority information 112 may be re-set as described above with respect to FIG. 2 (and discussed further, below, with respect to FIG. 6), and propagated to the shared hardware resources using direct wiring and/or replicated control fields (as in FIG. 3). Thus, for example, the priority identifier field 116 may continue to designate the first thread processor 102 as the high priority thread processor, while the priority level field 118 may indicate a priority level according to which the first thread processor 102 is allowed priority for accessing shared hardware resources.

Once the second job of the first process is completed, the priority information 112 may be re-set again, such that the first thread processor 102 is halted during a first job of the second process (518), while the second thread processor 104 executes the first job of the second process (520). Then, the second thread processor 104 may be provided with priority access to any shared hardware resources (522) while the second thread processor 104 executes a second job of the second process (524).

Thus, it should be understood that the priority information 112, or any portion thereof, may be set or re-set at virtually any point of the first or second process, according to the program 114. Also, portions of the priority information 112 may be set statically, and maintained through the most or all of the first or second process.

It should be understood that the terms “first job” or “second job” in FIG. 5 are not intended to refer necessarily to an actual first or second job, and are merely included to designate specific jobs within the context of FIG. 5. For example, it should be understood that a job of the second process may be executed during the second job of the first process (514/516), subject to the priority designation of the first thread processor 102. Also, various other jobs may be executed throughout the operation(s) of the flowchart 500, although not specifically illustrated in FIG. 5. For example, the priority information 112 may be re-set to provide fair access to the shared hardware resources for some period of time and/or some number of job(s), in which case neither the first thread processor 102 nor the second thread processor 104 may have priority access.

FIG. 6 is a flowchart 600 illustrating a second operation of the processor system of FIG. 3. In the example of FIG. 6, it is assumed that various operations such as a loading of the program 114, as well as the various initialization and/or enablement operations just described with respect to FIG. 5, have already been performed (including initialization of the priority information 112), and that the process(es) of the first thread processor 102 and/or the second thread processor 104 are being executed (602).

In this case, it may first be determined whether the process(es) require a halt of one of the thread processors (604), e.g., the second thread processor 104. If so, then a halt bit corresponding to the second thread processor 104 may be set within the halt field 120 may be set (606), in which case the second thread processor 104 will be caused to cease operations. If a restart is not determined (608), then the halting of the halted thread processor 104 continues until a restart is, in fact, permitted (e.g., as set by the program 114). Then, the second thread processor 104 may be restarted (610), and the execution of the process(es) may continue with, if necessary, a re-setting of the priority information 112 within the control register 110 (602).

In this example, once the priority information 112 is re-set, then no halt may be required (604). Instead, it may be determined whether requests from the first thread processor 102 and the second thread processor 104 have both been placed into a buffer and/or queue (612), such as the buffer/queue 310. If not, then it may somewhat similarly be determined whether substantially simultaneous requests have been received at a given shared hardware resource(s) (614). If so, and/or if requests from the first thread processor 102 and the 104 have been placed into the buffer/queue 310, then the control register 110 may be checked for relevant priority information 112 (616).

More specifically, as discussed above with respect to FIG. 3, controllers 320-326 associated with the buffer(s)/queue 308/310 and/or the caches 304/306 may analyze the requests to determine an included identifier of the first thread processor 102 and the second thread processor 104, and may then access priority bits within the priority information 112 that are associated with the corresponding buffer/queue or cache (e.g., may check a local, replicated control field, and/or may be directly wired to the necessary control information within the control register 110). In this way, access may be provided to the higher-priority thread processor.

Once the access is finished (620), then it is permissible to allow access to the other, lower-priority thread processor (622), e.g., the second thread processor 104. In case of a cache miss by the second thread processor 104 (624), then the second thread processor 104 will operate to re-fill a cache line of the cache from the main memory 318, but, as described with respect to FIG. 4 above, may be restricted from re-filling a portion of the cache that is partitioned and/or assigned to the first thread processor 102 (626). As should be understood, whether such a restriction is in place may be determined at a beginning of the process(es), and may thereafter be determined from a check of the priority information 112 in the control register 110. As shown in FIG. 6, a similar sequence may occur in a case where the cache has been partitioned, but there does not happen to have been either requests from multiple thread processors placed into a buffer/queue (612), or simultaneous requests received at the cache (614).

Finally, the priority information may be re-set and provided to the shared hardware resources, and the process(es) may continue (602) accordingly. In this way, at least some priority information may be set and re-set dynamically, so that the flow 600 may occur differently at different times (e.g., for different jobs) of the first and second processes.

It should be understood that the flow 600 is not intended necessarily to represent a literal or temporal sequence of events, since, for example, some of the operations may occur in parallel, and some of the operations may occur in a different order than that described and illustrated. Further, other operations also may be included, since, for example, a re-setting of the priority information (602) may cause a priority level in the priority level field 118 to indicate “fair” priority, in which case neither the first thread processor 102 or the second thread processor 104 may be able to receive priority access to shared hardware resources and/or set a halt bit for the other thread processor in the halt field 120. Similar comments are also applicable to the flowcharts 200 and 500 of FIGS. 2 and 5, respectively (i.e., those flowcharts are not intended necessarily to be sequential, exclusive, or comprehensive).

Although the above description is provided using the included terminology and examples, it should be understood that other terminology and examples also may be applicable. For example, other terminologies and examples for/of the systems of FIG. 1 and/or 3 include logical processors, time-slice multithreading processor systems, superthreading processor systems, hyperthreading processor systems, and/or simultaneous multi-threading (SMT) processor systems.

Similarly, although the examples are provided in terms of a single chip having the first thread processor 102 and the second thread processor 104, it should be understood that more than two thread processors may be used. Additionally, or alternatively, two or more physical processors, perhaps on more than one chip, may be used to implement the techniques described herein.

Also, although the examples of FIGS. 1 and 3 illustrate a single control register, the control register 110, it should be understood that a plurality of control registers may be used. Priority determinations are described herein on a resource-by-resource basis, so that, for example, the first thread processor 102 may have priority access to the instruction cache 304, while the second thread processor 104 may have priority access to the system interface 312. On the other hand, it should be understood that such priority determinations may be made according to groupings of the shared hardware resources. For example, the first thread processor 102 may have priority access to all of the caches, including the instruction cache 304, the data cache 306, and any other level-two caches that may be used.

Thus, as described, prioritized access to shared hardware resources may be provided to a thread processor, to one degree or another. In some implementations, complete prioritization is provided simply by halting an operation of another thread processor(s) for some determined time. In this way, the prioritized thread processor may operate quickly and reliably, and may provide results that are comparable to a case of a single (not multi-threaded) processor.

While certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the embodiments of the invention.

What is claimed is:

1. A method comprising:
setting priority information in a control register, the priority information being related to a first thread processor and a second thread processor;
executing a first process with the first thread processor and a second process with the second thread processor; and
prioritizing the first thread processor in performing the first process relative to the second thread processor in performing the second process, based on the priority information as determined from the control register.

2. The method of claim 1 wherein setting priority information in a control register comprises:
re-setting the priority information within the control register according to a program loaded to at least the first thread processor, after the prioritizing of the first thread processor in performing the first process.

3. The method of claim 1 wherein setting priority information in a control register comprises:
setting the priority information within the control register with respect to a first job of the first process.

4. The method of claim 1 wherein setting priority information in a control register comprises:
setting a bit pattern in the control register indicating thread-processor specific priority designations of a relative priority of the first processor with respect to the second processor.

5. The method of claim 1 wherein setting priority information in a control register comprises:
setting a priority level in the control register indicating an extent to which the first thread processor is prioritized in executing the first process, relative to the second thread processor in executing the second process.

6. The method of claim 1 wherein setting priority information in a control register comprises:
setting the priority information in the control register with reference to a designated shared hardware resource that is used by the first thread processor and the second thread processor during execution of the first process and the second process, respectively.

7. The method of claim 1 wherein setting priority information in a control register comprises:
setting the priority information to indicate an assignment of a portion of a cache to the first thread processor, the priority information designating a restriction on the second thread processor from re-filling at least some of the portion of the cache during execution of the second process.

8. The method of claim 1 wherein executing a first process with the first thread processor and a second process with the second thread processor comprises:
requesting, substantially simultaneously, a use of a shared hardware resource by the first thread processor and the second thread process in executing the first process and the second process, respectively.

9. The method of claim 1 wherein prioritizing the first processor in performing the first process relative to the second processor in performing the second process comprises:
receiving, at a shared hardware resource, a first request from the first thread processor and a second request from the second processor;
accessing the priority information in the control register; and
providing access to the shared hardware resource to the first thread processor, based on the priority information.

10. The method of claim 9 wherein receiving a first request from the first thread processor and a second request from the second processor, comprises:
receiving the first request and the second request at a controller of the shared hardware resource.

11. The method of claim 1 prioritizing the first processor in performing the first process relative to the second processor in performing the second process comprises:
restricting the second processor to re-fill a cache line only in an assigned portion of a cache during the second process.

12. The method of claim 1 prioritizing the first processor in performing the first process relative to the second processor in performing the second process comprises:
receiving a command or request associated with the first process at a buffer and/or a queue; and
advancing the command or request in the buffer and/or the queue, based on the priority information.

13. The method of claim 1 wherein prioritizing the first processor in performing the first process relative to the second processor in performing the second process comprises:
setting a halt bit in the control register that at least temporarily stops the second thread processor from performing the second process.

14. An apparatus comprising:
a first thread processor that is operable to execute a first process;
a second thread processor that is operable to execute a second process; and
a control register that is operable to store priority information that is individually associated with at least one of the first thread processor and the second thread processor, the priority information identifying a restriction on a use of a shared hardware resource by the second thread processor during execution of at least one of the first process and the second process.

15. The apparatus of claim 14 wherein the priority information includes:
a priority designation indicating a priority of the first thread processor relative to the second thread processor during a contention for use of the shared hardware resource; and
a priority level indicating a level of the priority.

16. The apparatus of claim 14 wherein the shared hardware resource includes a cache, and wherein the second thread processor is restricted from re-filling at least a portion of the cache following a cache-miss by the second thread processor.

17. The apparatus of claim 14 wherein the shared hardware resource includes one or more of a cache, a main memory, a buffer, a queue, an interconnect, an interface, a shared memory, a bus, a memory controller, or a shared device.

18. The apparatus of claim 14 wherein the control register includes a halt bit associated with the second thread processor that, when set, halts the second thread processor in performing the second process.

19. An apparatus comprising:
a plurality of thread processors that are operable to perform a plurality of processes;
a shared hardware resource used by the thread processors in performing the processes;
a controller associated with the shared hardware resource and operable to receive contending requests for the shared hardware resource from the plurality of thread processors; and
a control register associated with the shared hardware resource and operable to store priority information regarding use of the shared hardware resource by the plurality of thread processors,
wherein the controller is operable to receive the contending requests and access the control register to provide use of the shared hardware resource to a prioritized thread processor of the plurality of thread processors, based on the priority information.

20. The apparatus of claim 19 further comprising:
wherein the control register is associated with one of the plurality of thread processors and contains a corresponding halt bit, and
wherein the prioritized thread process is operable to halt an operation of the one of the plurality of thread processors, by setting the corresponding halt bit in the control register.
